(19) United States
(12) Patent Application Publication
(10) Pub. No.: US 2025/0093236 A1
(43) Pub. Date: Mar. 20, 2025

(54) WIRELESS SENSORS FOR A TIRE AND SENSING METHODS THEREOF

(71) Applicants: Indian Institute of Technology Madras (IIT Madras), Chennai (IN); Smartwheels LLC, Ashburn, VA (US)

(72) Inventors: QADEER AHMAD KHAN, Chennai (IN); SAURABH SAXENA, Chennai (IN); VAIBHAV SAXENA, Ashburn, VA (US); AMIT DESHPANDE, Baroda (IN)

(21) Appl. No.: 18/888,603

(22) Filed: Sep. 18, 2024

(30) Foreign Application Priority Data
Sep. 18, 2023 (IN) 202341062718

(51) Int. Cl. G01M 17/02; B60C 11/24; B60C 23/04; B60C 23/20; B60Q 9/00; G07C 5/08

(52) U.S. Cl. CPC G01M 17/02; B60C 11/246; B60C 23/0488; B60C 23/20; B60Q 9/00; G07C 5/0816

(57) ABSTRACT

A system for monitoring the condition of vehicle tires is disclosed. A method for monitoring the state of vehicle tires is also disclosed. The system includes a sensor unit, a sensor hub connected to the sensor unit, a processing unit and a power management unit. The sensor unit further includes plurality of sensors, an analog front end for processing and converting the analog signals to digital data, and a communication unit. A signal thresholding circuit is part of the analog front end. The condition of vehicular tires are monitored by determining the revolutions per minute (RPM) as well as the absolute number of revolutions of the tires. This facilitates in detecting bad road conditions, air leakage from tire, temperature and pressure of the tire and issue warnings to the user.

### CROSS-REFERENCES TO RELATED APPLICATION

This application takes priority to Indian patent application Ser. No. 20/234,1062718 titled “WIRELESS SENSOR FOR A TIRE AND METHODS THEREOF” filed on Sep. 18, 2023.

### FIELD OF INVENTION

The present disclosure relates to wireless monitoring sensors and in particular to tire monitoring sensors to determine their condition and other parameters such as number of revolutions, speed, pressure, temperature, etc. while driving.

### DESCRIPTION OF THE RELATED ART

In the recent past, there has been a great demand of wireless sensors for tires. Majority of the currently available sensors primarily offer pressure and temperature measurements. These sensors may be either mounted inside the tire or outside the tire. Further, in order to measure the actual life of the tire, there is a need to monitor the number of rotations (RPM) i.e. total distance covered by individual tires.

The most commonly used method for counting the revolution in a vehicle is by measuring the RPM of engine or crankshaft or wheel with the help of Hall Effect sensor mounted on anti-lock braking systems (ABS). Since existing sensors are mostly based on Hall Effect, they require stationary part along with the moving part i.e. wheels, hence cannot be installed inside the tire. Therefore, these sensors are suitable to measure only the RPM of wheel and not the individual tires. Further, in order to measure the RPM of an individual tire and retain the count irrespective of the location (when tires are rotated or changed) there is a need of in-tire RPM counter.

Various publications have tried to address the problem of correctly determining the RPM of a vehicle. US publication 10518590B2 discloses system for tracking tread wear of a tire of a vehicle. US publication 10000100B2 discloses determining tire load from measured tire parameters include using a piezoelectric based sensor to obtain one or more contact patch parameters. US application 20210125428A1 discloses a vehicle monitoring system for determining the state of a vehicle component. Japanese application 4629517B2 discloses power generator configured to generate a power output signal that is a pulse representative of the motion in response to the motion. Chinese application 106370441A discloses tire revolution number counting device and method. U.S. application Ser. No. 11/097,577B2 discloses tire health sensor assembly for arrangement in a vehicle tire.

Presently, there is a requirement for an in-tire RPM counter to measure the RPM of individual tires and retain the count irrespective of whether the tires are rotated or changed.

### SUMMARY OF THE INVENTION

The present subject matter relates to systems and methods for monitoring condition of vehicle tires. In various embodiments, a system for monitoring condition of vehicle tires, is disclosed. The system comprises a sensor unit placed within a tire, wherein the sensor unit includes a plurality of sensors, an analog front end to receive analog signals from the plurality of sensors and convert the analog signals to digital data, a processing unit for receiving the digital data from the plurality of sensors and to determine the revolutions per minute (RPM) of the tire using data pulses characteristic of a revolution count or a road condition or a vehicle safety condition with reference to a predetermined threshold, a communication unit for facilitating communication between the sensor unit and a sensor hub, and a power management unit for providing power to the sensor unit.

The system further includes a sensor hub configured to receive sensor data from a plurality of tires and to wirelessly communicate the data to a network, wherein the sensor hub is configured to receive and process the sensor data from the plurality of tires and provide one or more of a tire revolution count, a condition of road, or a condition of a tire; and generate a warning to a user in case of unsafe tire or road condition.

In various embodiments, the plurality of sensors in the sensor unit include a piezoelectric transducer, a pressure sensor, an angle sensor, a force sensor, an accelerometer, a gyroscope, a temperature sensor or a combination thereof.

In various embodiments of the system, the analog front end includes one or more of a filter, a comparator, a limiter, an analog to digital converter, or a multiplexer. The analog front end in various embodiments includes an adaptive threshold generation circuit to generate the predetermined threshold as a percentage of a peak signal.

In some embodiments, the power management unit includes a battery or a vibration energy harvester or a combination thereof, for powering the sensor unit, and a processor for optimizing power supply to the sensor unit using maximum power point tracking or other criteria.

In some embodiments, the system includes a server to store and analyze historical data of one or more vehicles and generate an alert relating to tire life, replacement schedule thereof, or road conditions to a user.

In various embodiments, the invention includes a method for monitoring the condition of vehicle tires, the method comprising receiving sensor data from a plurality of sensors of a sensor unit at an analog front end as analog signals, converting the analog signals to digital data at the analog front end, receiving and processing the digital data at a processing unit to generate time-stamped data pulses characteristic of a revolution count or a road condition or a tire safety condition, eliminating errors in RPM count, determining a road condition and a vehicle speed or both, communicating the digital data from the sensing unit to a sensor hub, generating a warning to the user in case of unsafe tire or road condition, and providing digital data from the sensor hub to a computing device over a network.

In some embodiments of the method, the pulses characteristic of a revolution count or a road condition are determined with reference to an adaptively generated signal threshold. In some embodiments, the threshold is dynamically set to a percentage of the peak sensor signal amplitude.

In various embodiments of the method, the sensor data includes one or more of a piezoelectric sensor signal, a pressure sensor signal, an angle sensor signal, a force sensor signal, an accelerometer sensor signal, a gyroscope sensor signal and a temperature sensor signal. In various embodiments of the method, the eliminating errors includes using a second sensor signal to correct RPM count obtained using a first sensor signal, wherein the first or the second sensor signal is a piezoelectric sensor signal, a pressure sensor signal, an angle sensor signal, a force sensor signal, an accelerometer sensor signal, or a gyroscope sensor signal.

In various embodiments, the eliminating errors includes determining a sudden change in time between two revolutions, determining if time between two revolutions is greater than maximum speed of the vehicle, or determining random time difference between two adjacent revolutions, and discarding the RPM count if above is true; else incrementing the RPM count.

In some embodiments of the method, eliminating errors in RPM includes determining a derivative of a sensor signal. In some embodiments, the method includes transmitting anomalies such as potholes, bumps, or rough road, to the sensor hub.

In various embodiments of the method, generating a warning to the user in case of unsafe vehicle or road condition comprises determining the tire pressure or temperature or both, comparing the tire pressure or temperature with predefined threshold values, and generating a warning to the user indicating unsafe tire conditions. In some embodiments of the method, the sensor unit enters standby mode when the vehicle is stationary and resumes active mode on movement of the vehicle.

In some embodiments, the method may further comprise tracking any or all of: a physical condition of a tire, an environmental condition of a tire or an operating condition of a tire. The physical condition of the tire may include tread depth or load. The environmental condition may include operating temperature. The operating condition may be selected from one or more of: torque, rolling resistance, braking distance, operational hours, dry or wet road condition associated with each tire's location. The method may thereby include providing enhanced predictive analytics for tire performance and maintenance.

This and other aspects are described herein.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1A illustrates a system for monitoring condition of vehicle tires, according to embodiments of the present subject matter.

FIG. 1B illustrates the sensing unit of the system.

FIG. 1C shows battery management system of the sensing unit.

FIG. 2A, 2B and 2C illustrate method of monitoring condition of vehicle tires, according to embodiments of the present subject matter.

FIG. 3 illustrates the RPM based on piezo sensor, according to an embodiment of the present subject matter.

FIG. 4 illustrates the RPM based on pressure sensor, according to an embodiment of the present subject matter.

FIG. 5 illustrates the RPM based on accelerometer, according to an embodiment of the present subject matter

FIG. 6 illustrates the RPM based on gyroscope, according to an embodiment of the present subject matter.

FIG. 7 illustrates the RPM based on angle sensor, according to an embodiment of the present subject matter.

FIG. 8 illustrates the generation of pulse with adaptive thresholding, according to an embodiment of the present subject matter.

FIG. 9 illustrates the RPM with error correction, according to an embodiment of the present subject matter.

FIG. 10 illustrates the RPM with derivative based error correction, according to an embodiment of the present subject matter.

FIG. 11A, 11B and 11C illustrate different methods of determining bad road conditions.

FIG. 12 illustrates the pulse diagram for various road conditions.

FIG. 13 illustrates the warning generation for the vehicle based on detection of alarm condition by the sensing unit.

FIG. 14 illustrates the air leakage detection for the vehicle.

FIG. 15A and 15B illustrate the activation and deactivation of sensors by sensor hub.

FIG. 16A and 16B illustrate the auto activation and deactivation of sensors.

FIG. 17 illustrates experimental setup used for generating rotation count data.

FIG. 18 shows piezoelectric sensor analog signals as a function of time.

FIG. 19 shows acceleration sensor analog signal variation with tire rotation.

FIG. 20 illustrates gyroscope sensor signal variation as a function of tire rotation.

FIG. 21 illustrates angle sensor signal as a function of tire rotation.

Referring to the figures, like numbers indicate like parts throughout the various views.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The present subject matter describes a system for monitoring the condition of vehicular tires by determining the revolutions per minute (RPM) of the tires. The system and method facilitate detecting bad road conditions, air leakage from tire, temperature and pressure of the tire and issue warnings to the user. Additionally, the system facilitates accurately predicting life of the tire based on the RPM and the conditions under which the vehicle is driven.

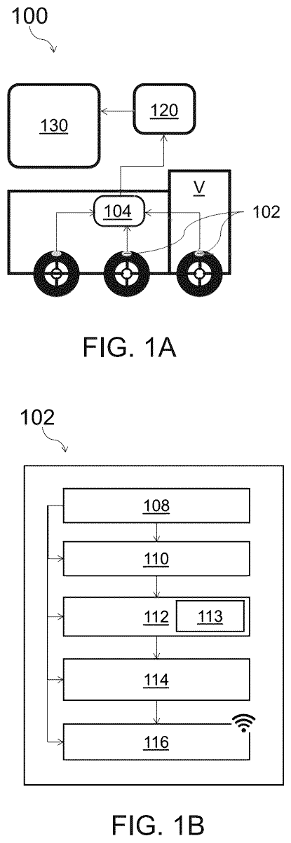

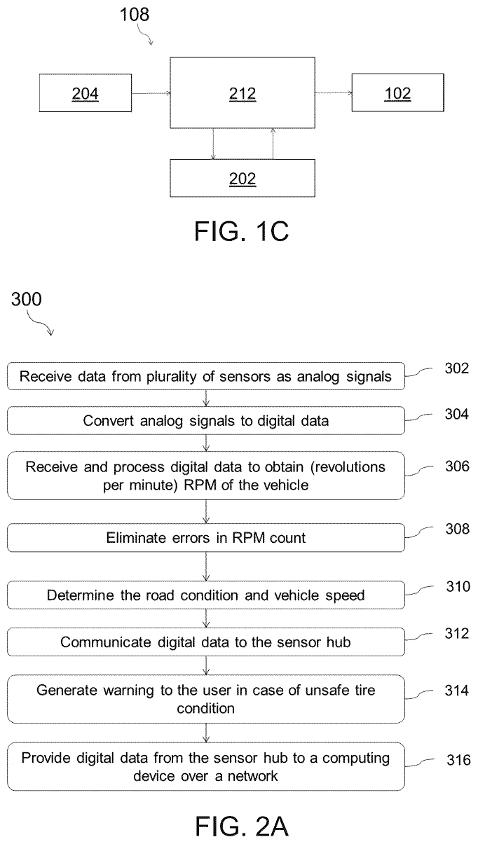

A system 100 for monitoring the condition of vehicle tires is illustrated in FIG. 1A in various embodiments of the subject matter. The system 100 includes at least one sensor unit 102 affixed to one or more tires of a vehicle, each sensor unit configured to communicate wirelessly with a sensor hub 104 located within the vehicle. In various embodiments, the sensor hub 104 is configured to collect the data from multiple sensor units 102 affixed to each tire of the vehicle. In various embodiments, the sensor hub 104 may communicate with a network 120 or a cloud server 130, or both. In some embodiments, the sensor hub 104 may be located on the dashboard of the vehicle, or it may be a mobile phone device carried by the operator of the vehicle.

As further illustrated in FIG. 1B, the sensor unit 102 includes a power management unit 108, a plurality of sensors 110, an analog front end 112, a processing unit 114, a communication unit 116. The analog front end 112 includes an adaptive threshold generation circuit 113. The sensors may include a piezoelectric transducer, a pressure sensor, an angle sensor, a force sensor, an accelerometer, a gyroscope, a temperature sensor or a combination thereof. The plurality of sensors is connected to the analog front end 112 for receiving and processing analog signals from the plurality of sensors. The analog front end may have one or more of a filter, a comparator, a limiter, an analog to digital converter, or a multiplexer for processing and converting the analog signals to digital data. The components of the analog front end are configured to remove noise, drift, or both. The digital data from the sensors 110 is then conveyed to the processing unit 114 by the analog front end 112. The communication unit 116 is connected to the processing unit 114 for transmitting the digital data to the sensor hub 104. In various embodiments, the processing unit 114 is configured to identify data pulses characteristic of a revolution count or a road condition or a vehicle safety condition with reference to a predetermined threshold, as generated by the adaptive threshold generation circuit 118. In various embodiments, the sensor unit 102 may be provided in each tire of a vehicle.

In various embodiments, the power management unit 108, as illustrated in FIG. 1C, is connected to the sensor unit 102 for powering the unit. The power management unit 108 may include a battery 202 or an energy harvester 204 or a combination thereof. The power management unit 108 also includes a processor 212 to regulate the voltage and charge the battery with maximum power using maximum power point tracking (MPPT).

In various embodiments, the system is configured to process the data at the sensor unit 102 to determine a tire revolution count, a bad road condition, or air leakage. The processing unit 114 is configured to receive and processes the sensor data obtained from the plurality of tires and provides data on one or more of: an error-corrected tire revolution count, a condition of road, or air leakage detection to the user and to generate a safety warning. In various embodiments, the processing unit 114 may be located on the dashboard of the vehicle, or a mobile phone of the vehicle operator. The processed data may be displayed to the user on a vehicle dashboard, mobile phone or any other device capable of display. In some embodiments, the sensor hub 104 is configured to wirelessly connect to a network 120 for transferring the data to a cloud server 130. The server 130 may store and analyze historical data of one or more vehicles and generate an alert relating to tire life, replacement schedule thereof, or road conditions to a user. In some embodiments, the historical data may also be stored as backup in a memory within the sensor unit 102 or the sensor hub 104.

In various embodiments, the processing of sensor data is done both at the sensor unit 102 as well as sensor hub 104. Some of the initial processing such as revolution count, bad road detection, safety conditions may be detected at the sensor unit. This is done to reduce the amount of data to be transmitted as well as to reduce power consumption. Any high-end processing which cannot be handled by the sensor unit is carried out at the sensor hub 104 or cloud server 130.

The sensor unit 102 may be connected to the sensor hub 104 using a wireless communications protocol such as Bluetooth, Wi-fi, Zigbee etc. The sensor hub may incorporate memory with software instructions for processing the received sensor data.

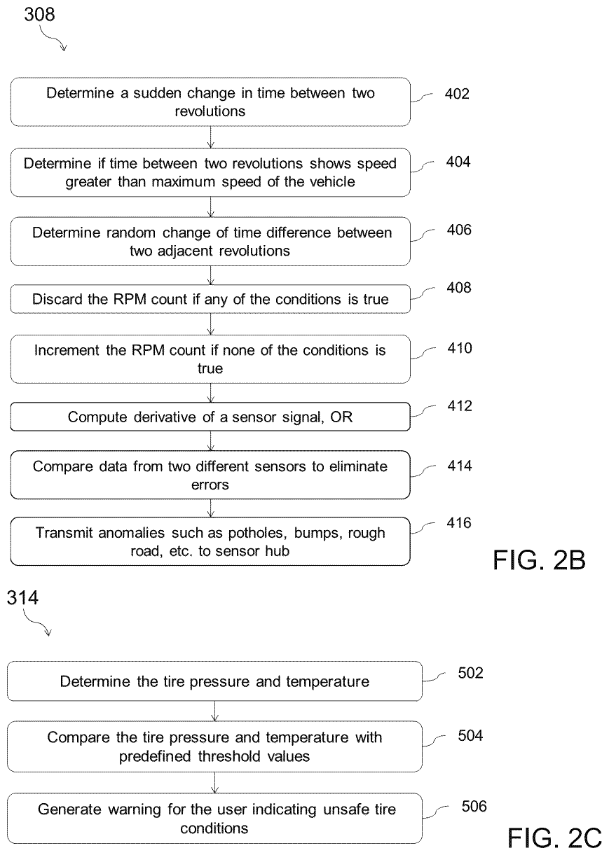

In various embodiments, the invention discloses a method 300 of obtaining the revolution per minute (RPM) or absolute number of revolutions of the vehicle tires as illustrated in FIG. 2A. The method in various embodiments may include determining the state of roadworthiness of the tires as well the condition of the roads on which the vehicle is being currently driven. The method 300 involves monitoring the sensor data corresponding to each tire. In a first step 302, sensor data is received from plurality of sensors 110 of a sensor unit 102 at an analog front end 112 as analog signals. In the next step 304 the analog signals are converted to digital data at the analog front end 112. In step 306, the digital data is received and processed at a processing unit 114 to generate time-stamped data pulses characteristic of a revolution count or a road condition or a vehicle safety condition, and determine the revolutions per minute (RPM) of the vehicle.

The digital data is processed to eliminate errors in step 308. In step 310 the road condition and vehicle speed are determined at the computing device 114 and in step 312 digital data from the sensor units 102 is transmitted wirelessly to the sensor hub 104.

In step 314, tire pressure or temperature or both are compared to a predetermined threshold and warning is generated to the user in case of unsafe tire or road condition.

In various embodiments, the method 300 includes determining the analog pulses as characteristic of a revolution count or a road condition with reference to a predetermined sensor signal threshold. In various embodiments, the threshold is set dynamically to a percentage of the peak sensor signal amplitude.

The time between the previous revolution and current revolution of tires is estimated as illustrated in FIG. 2B. In step 402 a sudden change in time between two revolution signals is detected. It is determined if time between two revolution signals corresponds to a speed greater than maximum speed of the vehicle detected by the preceding signals, in step 404. Further, a random change of time difference between two adjacent signals is detected in step 406. The signal is discarded for RPM count if any of the conditions indicate a change in revolutions in step 408 and in step 410 the RPM count is incremented if there are no sudden changes detected. In some embodiments, the method may include the step 412 of eliminating errors by computing derivative of a sensor signal. In alternative embodiments, the method may include using (414) a second sensor signal to correct RPM count obtained using a first sensor signal. The first or the second sensor signal may be one of a piezoelectric sensor signal, a pressure sensor signal, an angle sensor signal, a force sensor signal, an accelerometer sensor signal, or a gyroscope sensor signal. In some embodiments, the method includes transmitting (416) anomalies such as potholes, bumps, or rough road, to the sensor hub.

The generation of warning to the user in case of unsafe tire or road condition is illustrated in FIG. 2C. In step 502 the tire pressure and temperature of tire is determined. Further, in step 504 the determined tire pressure and temperature is compared with predefined threshold values and in step 506 a warning is generated for the user, indicating unsafe tire condition.

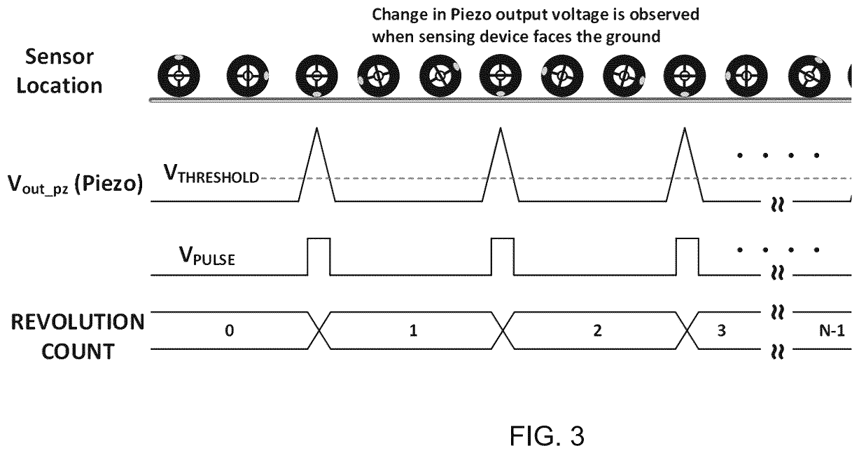

In various embodiments, the RPM of tires may be determined based on one or combination of sensors. FIG. 3 illustrates determining the RPM of tire based on piezoelectric sensor. The piezoelectric sensor produces electric charge when a mechanical stress/force is applied. The sensor is attached to the inner surface of the tire to observe the stress when that particular portion of the tire comes in contact with the ground. This produces an electric signal (V_{out-pz}) that is converted into a pulse signal (V_{PULSE}). The pulse signal is counted to obtain the revolution of the tire. Deflection of tire surface where the sensor is installed indicates the stress of the piezoelectric sensor. As the tire surface is deflected only when it comes in contact with the ground which happens only once in the entire cycle of revolution, the electrical signal produced by the sensor may be used to represent the number of tire revolutions.

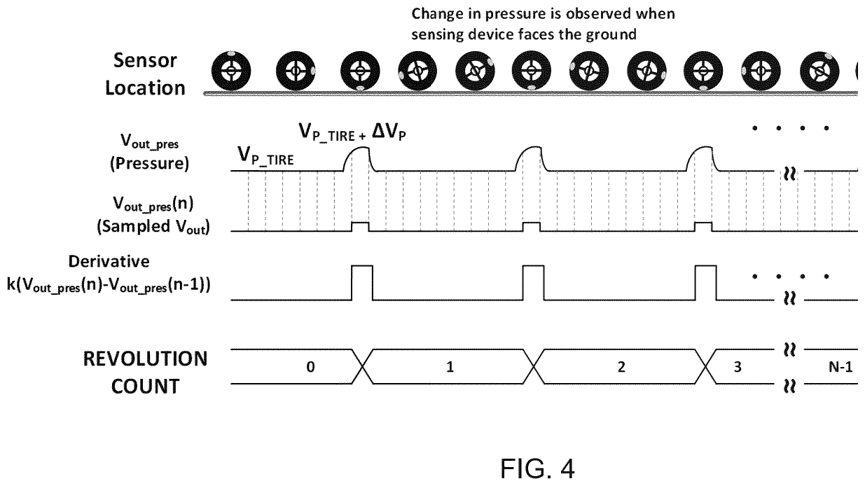

In various embodiments, a pressure sensor may be installed inside the tire to observe change in pressure when the tire location where pressure sensor is installed comes in contact with the ground. FIG. 4 illustrates determining the RPM of tire based on pressure sensor. The change in tire pressure is detected as electric signal produced by the pressure sensor and processed with derivative function and converted into pulses. These pulses are further counted to get the number of tire revolutions. The pressure sensor is useful in monitoring the actual tire pressure along with the revolution count using a single sensor.

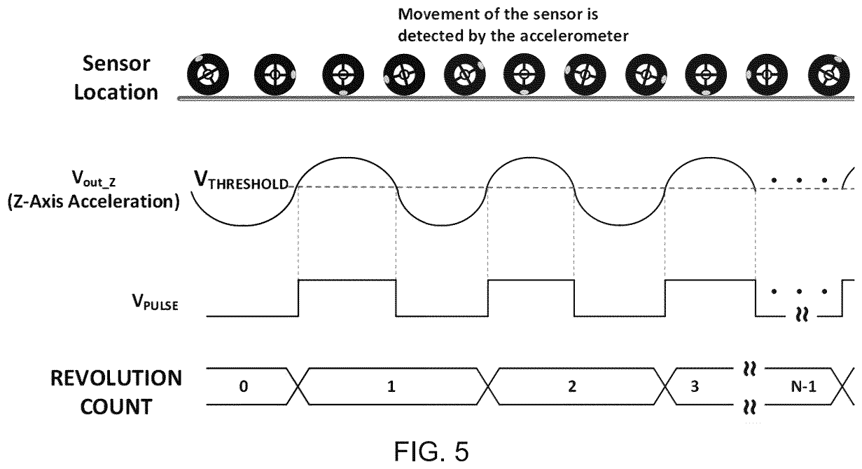

In some embodiments, RPM of the tire may be determined based on accelerometer used for measuring angular motion as well as acceleration as shown in FIG. 5. The electrical signal produced as angular motion when tire is in motion is utilized for detecting the number of revolution while change in acceleration may be used to detect the condition of road. On a smooth road, the signal produced by one or two of 3 axes (x, y and z) of the accelerometer is sinusoidal which is converted into a pulse signal and counted to obtain the number of tire revolutions. In bad road conditions, when tire encounters a pothole or bump, the accelerometer produces higher acceleration in the z-direction which is utilized for detecting the condition of road. The magnitude of acceleration in the z-direction may also be used to represent the severity of the pothole, bump and other anomalies.

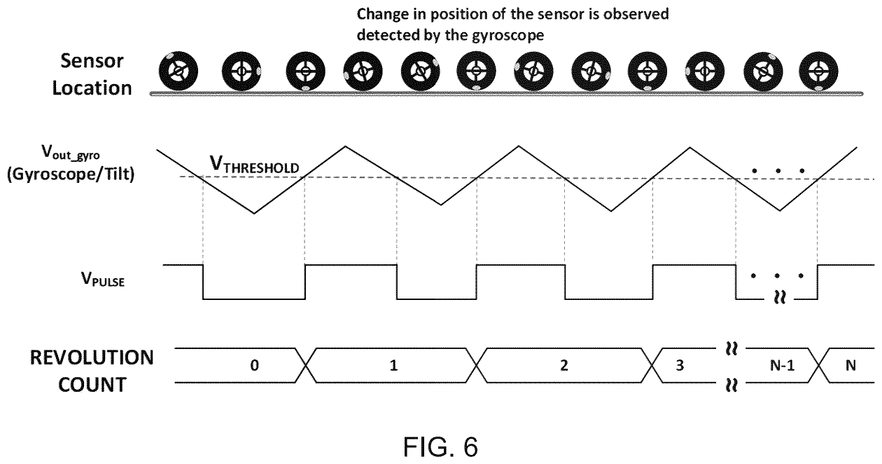

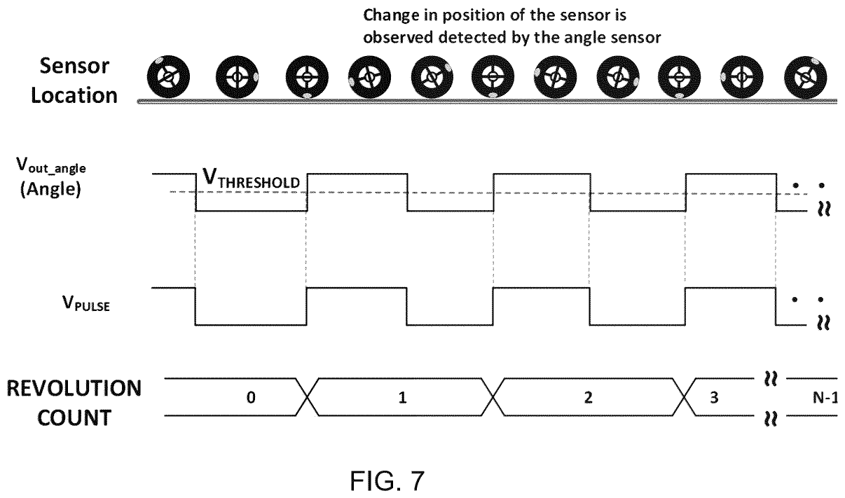

In some embodiments, a gyroscope or tilt sensor may be used to determine RPM as shown in FIG. 6. When the gyroscope is attached to a tire it facilitates in determining change in orientation of the tire during operation. Since the gyroscope goes through entire 360 degrees rotation, the electrical signal produced by the gyroscope is a periodic signal representing the angle of orientation at every point of the rotation. This periodic signal is converted into pulses and counted to get the number of tire revolution. RPM may also be obtained using an angle sensor which is similar to gyroscope except that it produces only two signal states, high or low, depending upon the orientation of the sensor as shown in FIG. 7. When the tire is in motion, the angle sensor faces upward (signaling low) in the lower half of the tire position while it faces downward (signaling high) in the upper half position of the tire.

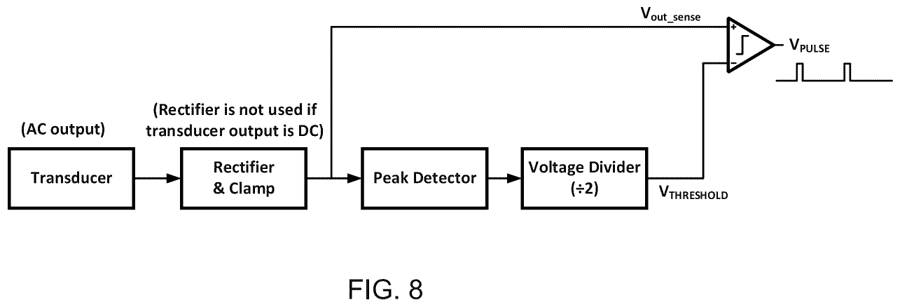

In various embodiments, RPM is calculated based on pulse signals generated by the plurality of sensors. Pulse signal is generated by comparing the output of sensors to a pre-defined threshold voltage. The threshold voltage may be set to half of the peak amplitude of the sensor output. For transducers producing the DC output, the signal may be directly fed to the comparator while for the sensors producing AC output, the signal is first rectified and then fed to the comparator. As amplitude of the transducer may vary based on the operating conditions such as tire pressure, mechanical stress, temperature, component tolerance, aging, etc., setting the threshold voltage to a fixed value may fail to detect the pulse under certain conditions and produce a wrong result. To overcome this eventuality, an adaptive threshold generator 118 may be used which automatically adjusts the threshold voltage to a percentage of the signal peak amplitude as shown in FIG. 8, using a divider circuit such as a 50% divider circuit.

However, in bad road conditions rough patches or potholes may be present on the road. In such rough road conditions, any of the sensors 110 may produce a pulse even when the tire surface is not in contact with the ground and therefore incorrect number of revolutions. Hence, error correction is performed to obtain the correct revolution under different road conditions. The additional signals or pulses due to bad road conditions may be used to detect the condition of the road.

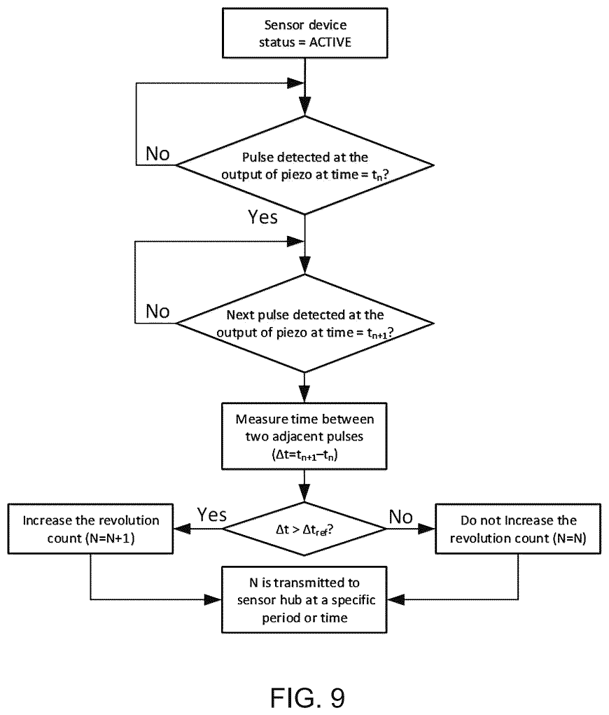

Error correction in step 316 of method 300 performed to obtain the correct revolution under different road conditions is illustrated in FIG. 9-11C. Pulses generated from the pulse generating comparator during the operation of the vehicle are counted using a digital counter that represents the number of tire revolutions. An N-bit counter is used and total count is stored in a memory like ROM that may be updated at predefined time intervals. The size of counter is defined based on the maximum revolution expected throughout the life span of the tire. Every time the device gets restarted, the counter is initialized with the count stored in the memory. In various embodiments, the count stored in the memory is transmitted to sensor hub 104 either at predefined time intervals or once in a day or every time before the sensing unit 102 enters a standby mode. In one embodiment, the error in revolution count due to bad road condition is corrected by measuring the time between two pulses. If time between two pulses is less than the predefined time Δt then the pulse is skipped, otherwise counted, as illustrated in FIG. 9. Time Δt may be either fixed, or dynamically adjusted to vary with the speed of vehicle.

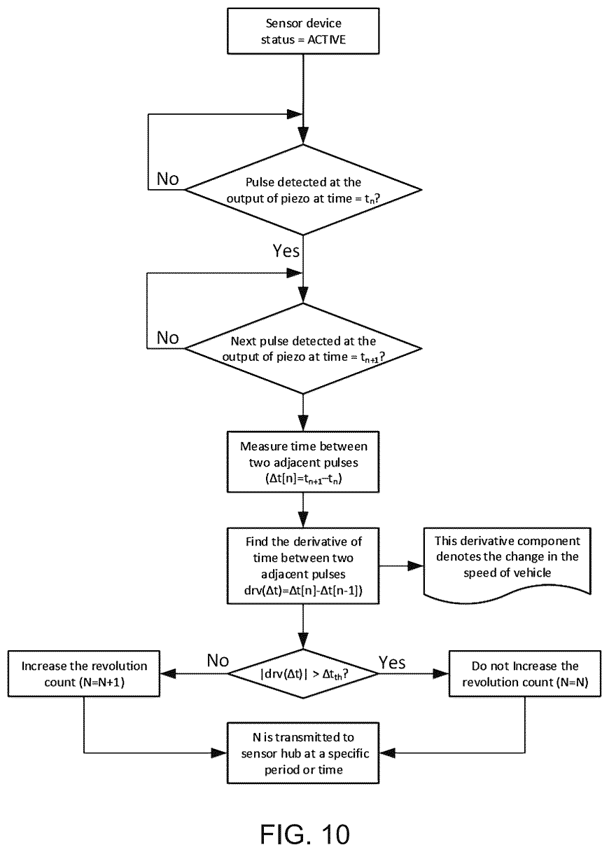

In some embodiments, the error correction in step 316 may use derivative of the time between signal pulses. FIG. 10 illustrates derivative based error correction, wherein the time between two adjacent pulses is continuously measured and compared with previous time difference between two pulses. If a sudden change in the time difference between two pulses is observed then it is detected as error and the corresponding pulse is skipped.

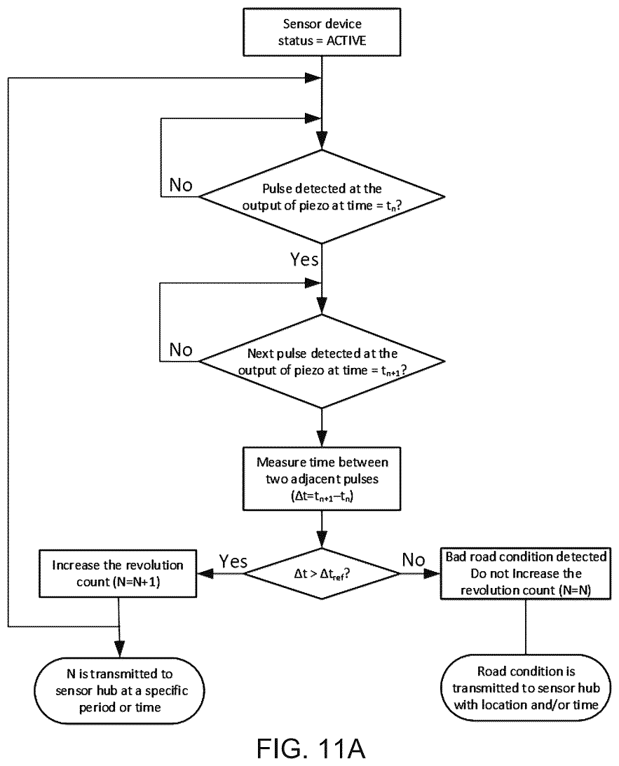

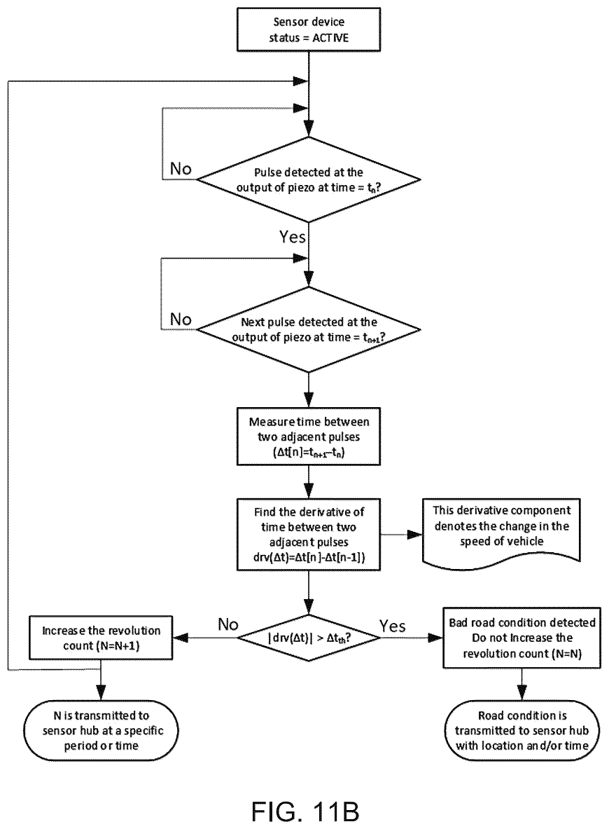

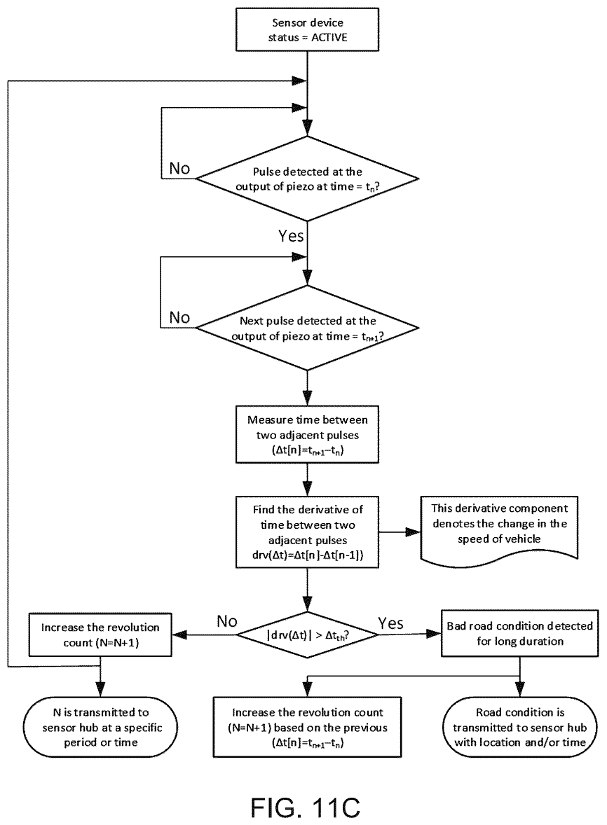

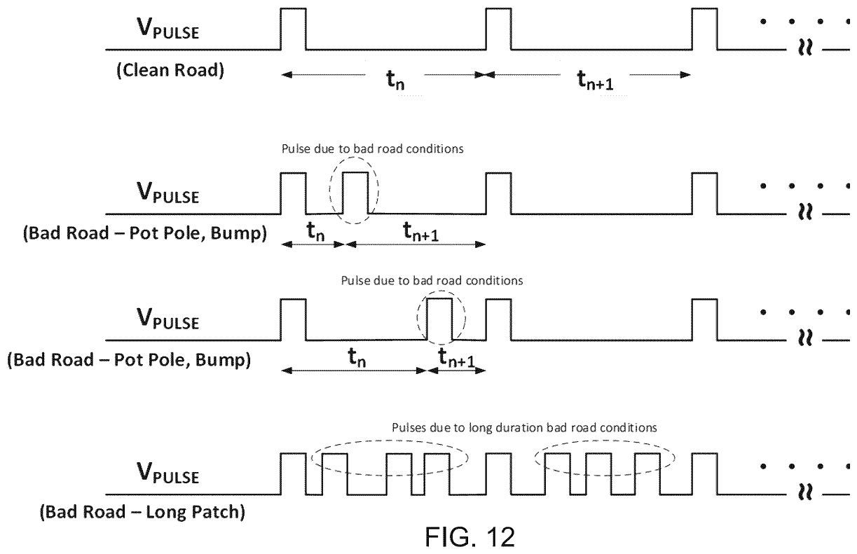

In various embodiments, FIGS. 11A and 11B illustrate detection of road conditions, particularly damaged roads that the vehicle may be travelling over for short periods of time. Error is detected with short time difference between two pulses or when sudden change in the time difference (derivative) indicates bad road conditions. A permanent bad road condition is recorded, if the error is detected by multiple tires at different times by the different vehicles. The sensor hub 104 may tag this road condition with location on a navigation map. The condition may also be used to warn the driver in advance when driving on such roads. The road condition may also be used by the highway authorities to know the condition in real time and take necessary action to prevent an accident. In case of bad road conditions for a longer distance, the time between two adjacent pulses may vary randomly for a longer period as shown in FIG. 11C. Under such conditions, the derivative of time difference between two pulses remains high for a longer time. Instead of increasing of counting the revolution with pulses, the count is increased based on the previous time (before the bad road condition) between pulses. The time duration for which bad road condition is detected may also be used to calculate the distance of persisting bad road conditions. FIG. 12 illustrates a pulse diagram for various adverse road conditions.

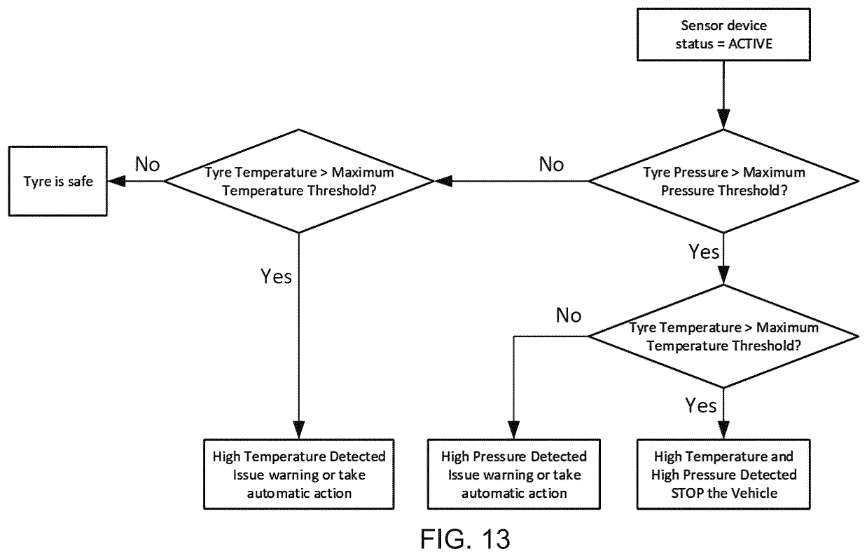

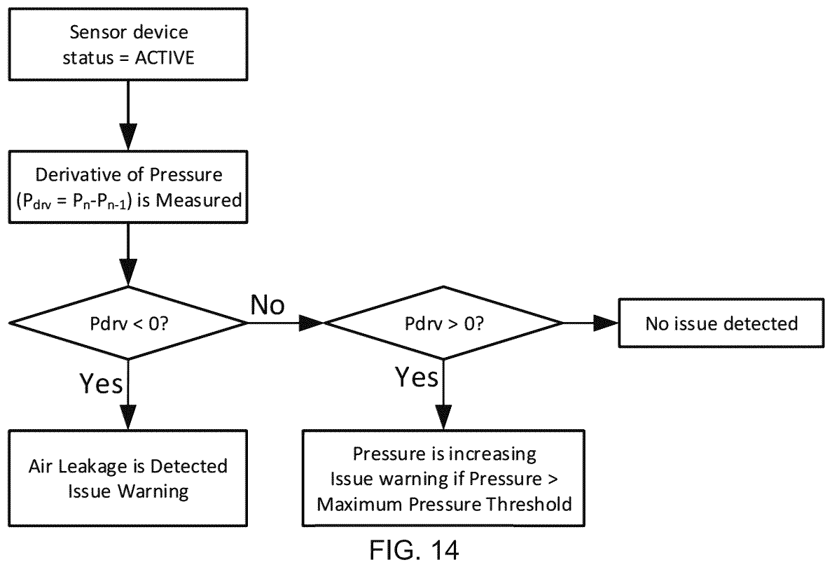

In some embodiments, the system 100 may also be utilized for determining the condition of the vehicle tires particularly conditions of high pressure as well as air leakage from the vehicle tires. High pressure and/or high temperature may lead to tire explosion and accidents. Such unsafe conditions may be detected and driver may be warned in advance as shown in FIG. 13. If the pressures of tire and/or temperature exceeds beyond the preset threshold values, then a warning is issued to the user. Air leakage or increasing pressure in the tire while the vehicle is moving may be detected by finding a change in pressure (derivative) as shown in FIG. 14. If tire pressure consistently decreases, it may indicate an air leak or a puncture and an appropriate warning is issued to the driver. If a consistent increase in tire pressure is detected for some reason, then a warning is issued as well.

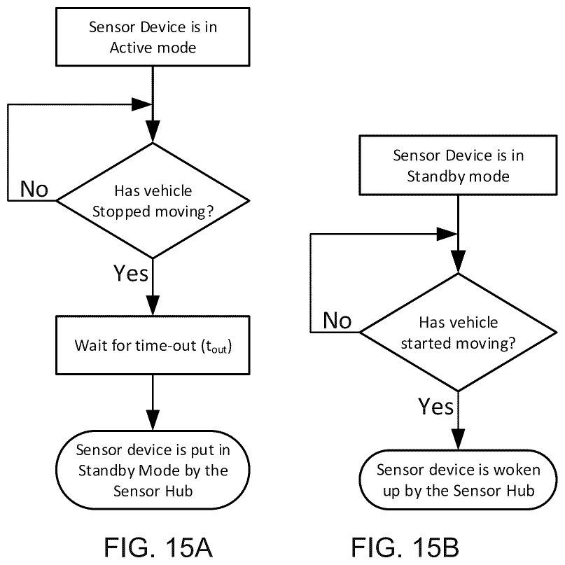

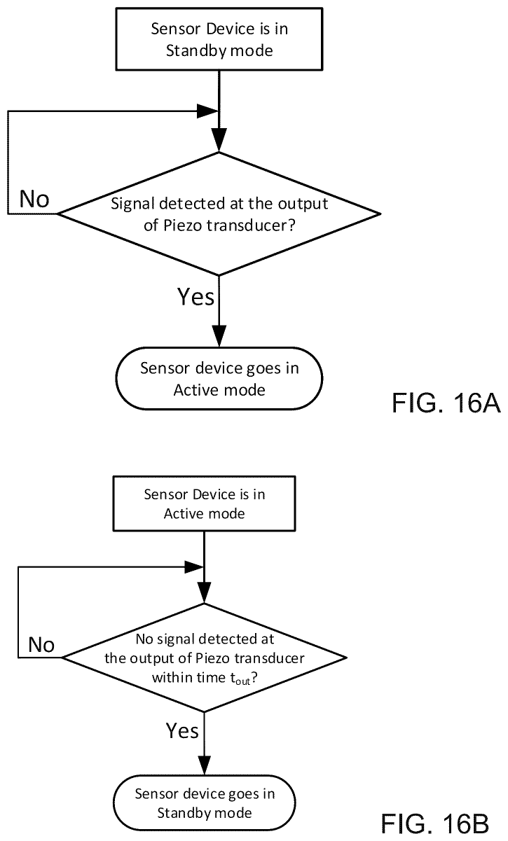

In various embodiments, the sensor unit 102 is activated or deactivated by the sensor hub 104 to reduce drain on the power used, as shown in FIGS. 15A and 15B. The sensor unit 102 is deactivated or enters a standby mode when the vehicle is not in motion. Sensor hub 104 may wirelessly transmit the command for deactivation/standby mode to the sensor units 102 installed in various tires of the vehicle. In standby mode, the sensor unit 102 remains inactive and wakes up upon receiving a wakeup command from the sensor hub 104. The wakeup command is sent by the sensor hub 104 when vehicle starts moving that activates the sensor unit 102. To prevent the sensor unit 102 from entering standby mode during temporary vehicle halt, a timeout period is specified so that the sensor unit 102 enters standby mode only when the vehicle remains at halt beyond the specified timeout period. The sensor unit 102 may be activated or deactivated automatically by detecting whether the vehicle is in motion or at rest, as shown in FIGS. 16A and 16B. The transducer signal detection circuitry i.e. the pulse generating comparator remains always active to detect pulses from the sensors. When no pulses are detected for more than the specified timeout period, then the vehicle is considered to be at rest and the sensor unit 102 enters the standby mode. The sensor unit 102 is activated when a pulse is detected at the output of the pulse generating comparator.

In some embodiments, the eliminating errors may include using a second sensor signal to correct RPM count obtained using a first sensor signal. The first or the second sensor may be any of the sensors except temperature sensor. For instance, the angle sensor, accelerometer sensor or gyroscope sensor pulses may be used to correct RPM values obtained using the piezoelectric sensor, or the pressure sensor.

In some embodiments, the method 300 may further comprise tracking any or all of: a physical condition of a tire, an environmental condition of a tire or an operating condition of a tire. The physical condition of the tire may include tread depth or load. Tread depth may be detected by change in amplitude of the piezoelectric signal. Deep treads may reduce amplitude of the piezoelectric signal, while increase in signal amplitude may signify wear of the tire. Similarly, the signal amplitude may be enhanced by increasing load. The method may include identifying a specific signature variation in the data for each condition. The environmental condition may include operating temperature.

The operating condition may be selected from one or more of: torque, rolling resistance, braking distance, operational hours, dry or wet road condition associated with each tire's location. The operating conditions may be monitored at the sensor hub 104. Torque and rolling resistance may be computed from accelerometer sensor data or force sensor data or both. Braking distance may be computed from tire rotation count and tire dimensions. Operational hours may be obtained from the time stamping of signals recorded. Wet road conditions may be determined using reduction in sensor signal amplitude or damping associated with wet surfaces. The method may thereby include providing enhanced predictive analytics for tire performance and maintenance.

The system 100 for monitoring the condition of vehicle tires has several advantages over the present prior art. Multiple sensors are utilized for detecting the revolution of tires and error correction is adopted to eliminate the possibility of false count of RPM. Further, the RPM count also indicates the condition of the road the vehicle is travelling on. In particular, bad road conditions may be detected and the user accordingly informed. Additionally, the sensors may also be used to detect high pressure and high temperature of the tire or any air leakage from the tires.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here, and as delineated in the claims appended hereto.

### EXAMPLES

### Example 1: Implementation for Tire Monitoring

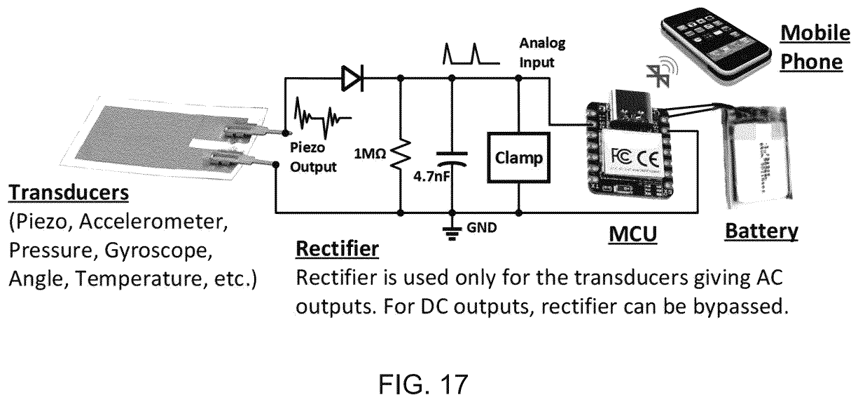

The hardware used for building the system was built and setup using the following devices—Seeed Xiao nRF52840 which contains: Microcontroller Unit (MCU), Bluetooth wireless connectivity and Analog Front-End (Comparator, A/D converter, etc.), as illustrated in FIG. 17. Two piezoelectric transducers were used, regular disc piezo and flexible piezo. Although both produced expected results, the regular disc piezo broke quite often due to its brittle nature. The piezo was installed on the inner surface of the tire in order to get the maximum stress and hence high magnitude of the electrical signal produced by the transducer. ADXL355 analog accelerometer from Analog Devices was used. MPU6050 digital gyroscope was used interfaced with the digital serial input of the microcontroller module Seeed XIAO nRF82540. RPI1031 angle sensor was used which produces only two signal states high and low.

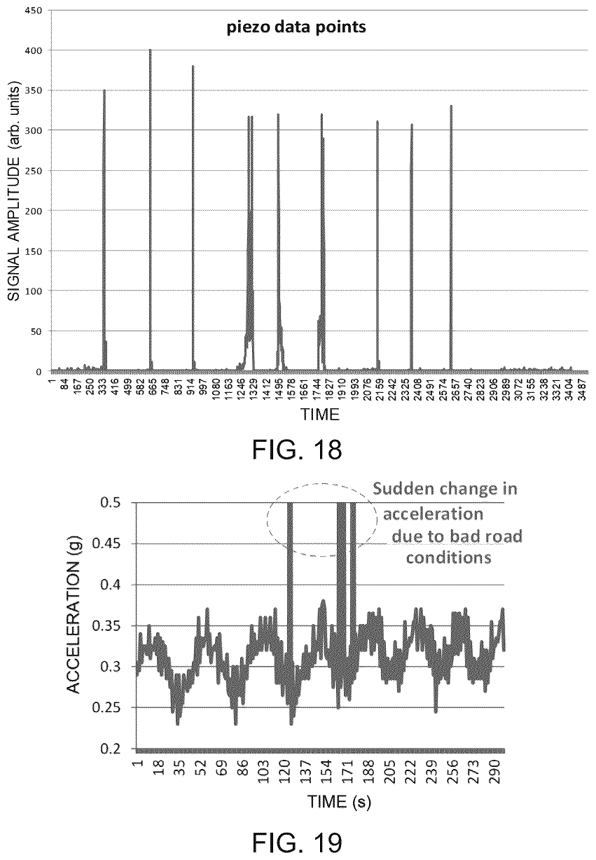

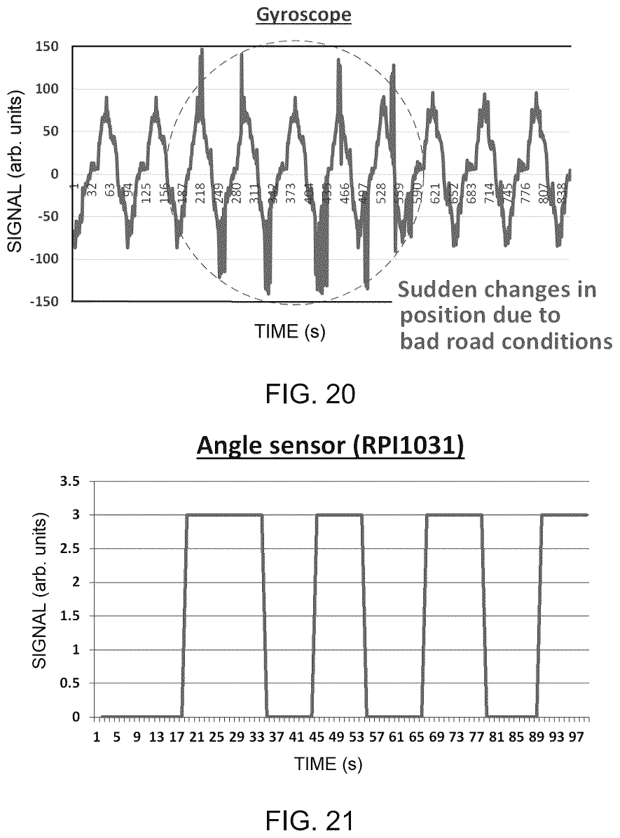

Since the electrical signal generated from the piezoelectric transducer is oscillatory in nature with both negative and positive peaks, it was converted into a single positive peak using a rectifier circuit. The maximum voltage supported by the microcontroller was usually 3.3V, so that the amplitude of the analog signal produced by the piezoelectric transducer was clamped to around 3V by using a clamp circuit which could be a Zener diode or series connected PN junction diodes. The sensor units were experimentally installed inside the tires of two-wheelers as well as four-wheelers, for testing. Actual analog pulses obtained using the various sensors are illustrated in FIG. 18-21. Pulses from the piezoelectric sensor are shown in FIG. 18, while FIG. 19 shows accelerometer sensor readings under different road conditions. Gyroscope sensor readings are shown in FIG. 20, while angle sensor signals are shown in FIG. 21.

We claim:

1. A system for monitoring condition of vehicle tires, the system comprising:
a sensor unit placed within a tire, wherein the sensor unit includes:
a plurality of sensors;
an analog front end to receive analog signals from the plurality of sensors and convert the analog signals to digital data;
a processing unit for receiving the digital data from the plurality of sensors and to determine the revolutions per minute (RPM) of the tire using data pulses characteristic of a revolution count or a road condition or a vehicle safety condition with reference to a predetermined threshold;
a communication unit for facilitating communication between the sensor unit and a sensor hub; and
a power management unit for providing power to the sensor unit;
a sensor hub configured to receive sensor data from a plurality of tires and to wirelessly communicate the data to a network,
wherein the sensor hub is configured to receive and process the sensor data from the plurality of tires and provide one or more of a tire revolution count, a condition of road, or a condition of a tire; and
generate a warning to a user in case of unsafe tire or road condition.

2. The system as claimed in claim 1, wherein the plurality of sensors in the sensor unit include a piezoelectric transducer, a pressure sensor, an angle sensor, a force sensor, an accelerometer, a gyroscope, a temperature sensor or a combination thereof.

3. The system as claimed in claim 1, wherein the analog front end includes one or more of a filter, a comparator, a limiter, an analog to digital converter, or a multiplexer.

4. The system as claimed in claim 3, wherein the analog front end includes an adaptive threshold generation circuit to generate the predetermined threshold as a percentage of a peak signal.

5. The system as claimed in claim 1, wherein the power management unit includes a battery, a vibration energy harvester or a combination thereof, for powering the sensor unit, and a processor for optimizing power supply to the sensor unit using maximum power point tracking or other criteria.

6. The system as claimed in claim 1, including a server to store and analyze historical data of one or more vehicles and generate an alert relating to tire life, replacement schedule thereof, or road conditions to a user.

7. A method for monitoring the condition of vehicle tires, the method comprising:
receiving sensor data from a plurality of sensors of a sensor unit at an analog front end as analog signals;
converting the analog signals to digital data at the analog front end;
receiving and processing the digital data at a processing unit to generate time-stamped data pulses characteristic of a revolution count or a road condition or a tire safety condition;
eliminating errors in RPM count;
determining a road condition and a vehicle speed or both;
communicating the digital data from the sensing unit to a sensor hub;
generating a warning to the user in case of unsafe tire or road condition; and
providing digital data from the sensor hub to a computing device over a network.

8. The method as claimed in claim 7, wherein the pulses characteristic of a revolution count or a road condition are determined with reference to an adaptively generated signal threshold.

9. The method as claimed in claim 8, wherein the threshold is dynamically set to a percentage of the peak sensor signal amplitude.

10. The method as claimed in claim 7, wherein the sensor data includes one or more of a piezoelectric sensor signal, a pressure sensor signal, an angle sensor signal, a force sensor signal, an accelerometer sensor signal, a gyroscope sensor signal and a temperature sensor signal.

11. The method as claimed in claim 10, wherein the eliminating errors includes using a second sensor signal to correct RPM count obtained using a first sensor signal, wherein the first or the second sensor signal is a piezoelectric sensor signal, a pressure sensor signal, an angle sensor signal, a force sensor signal, an accelerometer sensor signal, or a gyroscope sensor signal.

12. The method as claimed in claim 7, wherein estimating the eliminating errors includes:
determining a sudden change in time between two revolutions;
determining if time between two revolutions is greater than maximum speed of the vehicle; or
determining random time difference between two adjacent revolutions; and
discarding the RPM count if above is true; else
incrementing the RPM count.

13. The method as claimed in claim 7, comprising transmitting anomalies such as potholes, bumps, or rough road, to the sensor hub.

14. The method as claimed in claim 7, wherein eliminating errors in RPM includes determining a derivative of a sensor signal.

15. The method as claimed in claim 7, wherein generating a warning to the user in case of unsafe vehicle or road condition comprises:
determining the tire pressure or temperature or both;
comparing the tire pressure or temperature with predefined threshold values; and
generating a warning to the user indicating unsafe tire conditions.

16. The method as claimed in claim 7, wherein the sensor unit enters stand-by mode when the vehicle is stationary and resumes active mode on movement of the vehicle.

17. The method as claimed in claim 7, further comprising tracking any or all of:
a physical condition of a tire including tread depth or load;
an environmental condition including operating temperature; or
an operating condition selected from one or more of: torque, rolling resistance, braking distance, operational hours, dry or wet road condition associated with each tire's location, thereby providing enhanced predictive analytics for tire performance and maintenance.
